(19) United States
(12) Patent Application Publication
(10) Pub. No.: US 2024/0398054 A1
(43) Pub. Date: Dec. 5, 2024

(54) METHOD FOR PRODUCING A PADDING AND PADDING THUS PRODUCED

(71) Applicant: CYTECH S.R.L., SAN VENDEMIANO (IT)

(72) Inventors: Denis BERTOLDO, FIUME VENETO (IT); Enrico CAMPARI, BOLOGNA (IT); Laura MAZZOCCHETTI, BOLOGNA (IT); Luigi ANGIOLINI, BOLOGNA (IT); Niccolò GIANI, BOLOGNA (IT)

(73) Assignee: CYTECH S.R.L., SAN VENDEMIANO (IT)

(21) Appl. No.: 18/697,285

(22) PCT Filed: Sep. 29, 2022
(86) PCT No.: PCT/IT2022/050266

§ 371 Date: Mar. 29, 2024

(30) Foreign Application Priority Data
Sep. 30, 2021 (IT) 102021000025094

(51) Int. Cl. A41D 31/28; B29C 64/118; B29L 31/48; B33Y 10/00; B33Y 80/00

(52) U.S. Cl. CPC A41D 31/285; B29C 64/118; B29L 2031/4857; B29L 2031/4864; B33Y 10/00; B33Y 80/00

(57) ABSTRACT

Method for producing a padding (10) by means of 3D printing by deposition of at least one first filament directly onto a portion of fabric (18) to make at least the first layer of a plurality of layers that define a multi-plane structure.

### FIELD OF THE INVENTION

The present invention concerns a method for producing a padding, and the padding thus produced. The padding according to the present invention can be used preferably, but not exclusively, to make protective elements and sports garments, such as for example chamois for cyclists, gloves, helmets, insoles, or suchlike.

### BACKGROUND OF THE INVENTION

In the sports field, it is known to use protective elements that comprise one or more paddings in order to improve the comfort and safety of athletes.

For example, in cycling and horse riding, it is known to use shorts that comprise one or more paddings, located in the part astride the legs, in order to protect the zone of the body that during sports activity is in contact with the saddle, and therefore subjected to continuous friction and compression stresses. These shorts, or their portion that comprises the padding, are called “chamois” or “pads” in jargon.

Gloves are also known, for example used in cycling or motorcycling, which comprise at least one padding, located in correspondence with the palm of the hand in contact with the handlebar grips, which considerably improve comfort during sports activity and reduce the risk of problems arising, for example with the skin of the hand, due to rubbing with the handlebar grips as above.

These paddings are generally made of polyurethane foam, for example by overlapping and gluing two or more layers of foam that have different densities and/or thicknesses.

These paddings have a spongy structure, comprising bubbles that form during the expansion of the foams.

During sports activity, in the zone where the skin is in contact with such paddings, the temperature is high due to the rubbing and the almost total absence of heat exchange.

This causes a high level of sweating and consequently the onset of skin irritation and the proliferation of bacteria. The particular conformation of the polyurethane foams prevents good ventilation, even if low density foams are used.

Producing paddings with thicknesses and stiffnesses that vary from zone to zone is particularly complicated if these are made of polyurethane foam.

The cutting, assembly and gluing of the various portions requires high precision and long processing times, which result in high costs; furthermore, the mechanical properties of the finished paddings may still not meet the project specifications, due to the intrinsic defects of the materials used to produce them mentioned above.

There are also known paddings produced by means of additive 3D printing which are made by depositing various layers of a filament in order to create a regular structure consisting of cells.

However, the particular regularity of such structures often causes the failure of the cells due to the peak load effect, or buckling effect, generated by the pressure to which they are subjected during use.

Such paddings are generally associated with the protective element, for example a pair of cycling shorts, through thermoforming, gluing, high frequency or stitching of the paddings between two layers of fabric constituting the protective element.

These known types of association methods cause the formation of a rigid perimeter seam which, in addition to stiffening the entire protective element, decreases its comfort during use and reduces its aesthetic appeal.

US2020/390169A describes a protective glove that has a padding made by means of 3D printing.

DE102017101026A1 describes a protective element for a part of a user's body comprising a plurality of layers.

There is therefore the need to perfect a padding that can overcome at least one of the disadvantages of the state of the art.

To do this, it is necessary to resolve the technical problem of producing a padding for protective elements that has zones with a different resistance, which ensures high breathability and guarantees a high level of comfort for the user.

In particular, one purpose of the present invention is to provide a padding, and to perfect a method for producing such padding, which has a high elastic response.

Another purpose of the present invention is to provide a padding, and to perfect a method for producing such padding, the structure of which is not subject to peak load effects.

Another purpose of the present invention is to produce a single-piece padding, so as to improve its durability over time and reduce processing scraps and waste.

The Applicant has devised, tested and embodied the present invention to overcome the shortcomings of the state of the art and to obtain these and other purposes and advantages.

### SUMMARY OF THE INVENTION

The present invention is set forth and characterized in the independent claim. The dependent claims describe other characteristics of the present invention or variants to the main inventive idea.

In accordance with the above purposes and to resolve the above technical problem in a new and original way, also obtaining considerable advantages compared to the state of the prior art, a method for producing a padding according to the present invention by means of 3D printing by deposition of at least one filament provides to define a multi-plane structure comprising a plurality of overlapping layers, wherein the at least one filament is deposited directly onto a portion of fabric to make at least the first layer of the plurality of layers.

Doing so achieves the advantage of creating a padding with a programmable internal architecture, such as to improve the elastic response and durability over time compared to the paddings of the state of the art.

The method also allows to considerably reduce the processing times required for production, with a consequent saving in terms of labor and final costs.

By depositing the at least one the filament directly onto the portion of fabric, it is possible to avoid multiple processing steps which are indispensable in the state of the art, such as for example centering the padding, or the chamois that comprises it, in the garment, gluing it and sewing it.

In addition to reducing the number of possible defects of the finished product, this allows to increase the elasticity of the padding and the elastic harmony between the latter and the garment it is associated with.

Furthermore, this method achieves the advantage of adapting the padding to the shapes of its user, as a function of his/her anatomical requirements.

In accordance with another aspect of the present invention, the at least one filament is made of thermoplastic elastomer material (TPE) and the at least one filament has a hardness comprised between 40 Shore A and 95 Shore A, preferably comprised between 50 Shore A and 90 Shore A, even more preferably comprised between 60 Shore A and 80 Shore A.

In accordance with another aspect of the present invention, the portion of fabric comprises polyurethane or its derivatives.

In accordance with another aspect of the present invention, at least one portion of the structure is made by depositing at least one second filament having a hardness different from the hardness of the first filament.

In accordance with another aspect of the present invention, the first filament is deposited at a speed comprised between 400 mm/min and 4200 mm/min, preferably between 450 mm/min and 3000 mm/min, even more preferably between 500 mm/min and 1800 mm/min.

In accordance with another aspect of the present invention, the printing temperature is comprised between 170° C. and 260° C., preferably between 200° C. and 250° C., even more preferably between 220° C. and 240° C.

In accordance with another aspect of the present invention, the portion of fabric is comprised in, or associated with, a sports garment.

In accordance with another aspect of the present invention, the padding comprises an external perimeter zone, having an external edge the height of which is lower than the height of at least one central zone, and the variability of the height from such perimeter zone to such central zone can be in constant or non-constant progression.

In accordance with another aspect of the present invention, a sports garment comprises at least one padding as described above which can be a chamois, a glove or a pair of shorts.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is an exploded schematic view of a padding according to the present invention;

FIG. 2 is a perspective and schematic view of the padding of FIG. 1;

FIG. 3 is a top view of a padding according to the present invention in accordance with a second embodiment;

FIG. 4 is a lateral section view of the padding of FIG. 3;

FIG. 5 is a detail of FIG. 4;

FIG. 6 is a perspective and schematic view of a padding according to the present invention in accordance with a third embodiment;

FIG. 7 is a perspective view of a padding according to the present invention in accordance with a fourth embodiment;

FIG. 8 is a perspective and schematic view of a padding according to the present invention in accordance with a fifth embodiment;

FIG. 9 is a perspective and schematic view of a padding according to the present invention in accordance with a sixth embodiment.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

With reference to FIG. 1, a padding 10 according to the present invention comprises a multi-plane structure 11 obtained by overlapping a plurality of layers 12.

The padding 10 can be produced by means of additive 3D printing, for example, by means of additive printing by deposition of at least one first filament 13 and possibly at least one second filament 130.

The filaments 13, 130 used for the additive printing can be made, for example, of thermoplastic elastomer material (TPE), or any other material suitable for contact with a person's skin without causing irritation or problems of a different nature.

The use of thermoplastic elastomer materials is preferred, since these are chemically similar to polyurethane foam and they have the same degree of compatibility for contact with the skin, consequently their use is particularly advantageous.

Furthermore, the filaments 13, 130 could be made of materials of natural origin, recycled materials or both.

For example, the thermoplastic elastomer materials used could have a hardness comprised between 40 Shore A and 95 Shore A, preferably comprised between 50 Shore A and 90 Shore A, even more preferably comprised between 60 Shore A and 80 Shore A.

In addition, the use of these materials easily allows to add substances with antibacterial, anti-inflammatory and soothing properties.

FIG. 1 shows, by way of example, a schematic representation of the first layers 12, respectively 12a, 12b, 12c, 12d and 12e, of a padding 10 according to the present invention.

According to some embodiments, each layer 12 can also be made by means of additive printing by deposition of at least one second filament 130.

For example, each layer 12 could comprise a portion made with the first at least one filament 13 and at least a second portion made with the second filament 130.

The second filament 130 used for the additive printing can be made of the same material with which the at least one first filament 13 is made or, for example, with a different thermoplastic elastomer material. This can be, for example, a filament for 3D printing having a hardness, in Shore A terms, different from the hardness of the first filament 13, as will be better described below.

Each layer 12 can be produced by depositing at least one first filament 13, or at least one second filament 130, according to a specific pattern of deposition, for example open or closed.

Here and hereafter in the description, by pattern, or pattern of deposition, we mean the particular trajectory followed by the nozzle with which the filament 13, 130 is deposited and, consequently, the geometric structure of the filament 13, 130 once this has solidified after printing.

For example, the open pattern of deposition could be linear, as shown in the layers 12b, 12c, 12d and 12, and the closed pattern could be with rings or polygonal, for example with a hexagonal pattern (layer 12a of FIG. 1), a triangular or square pattern.

Furthermore, each layer 12 could be made with several patterns of deposition, for example, one of the layers 12 (not shown in the drawings) could have one portion made with a pattern with rings, one portion made with a linear pattern and one portion made with a hexagonal pattern. In this way, each layer 12 could have portions with different mechanical properties from each other, as will be better described hereafter in the description.

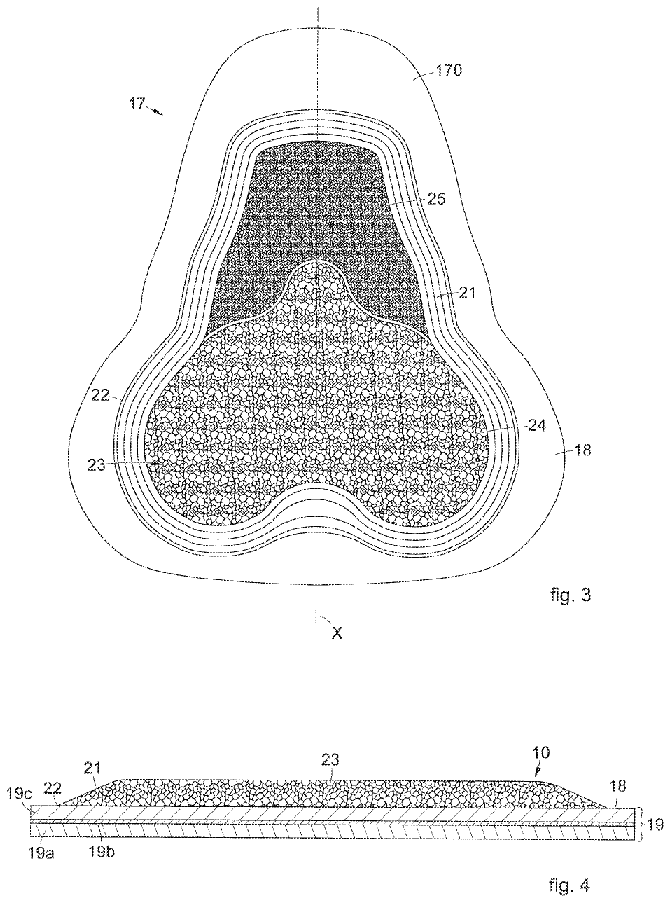

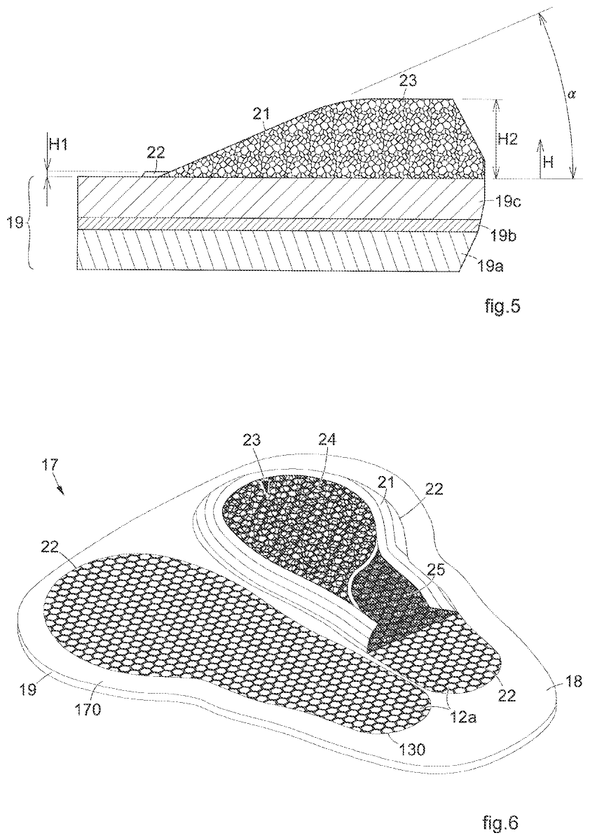

The plan view conformation of each of the layers 12, obtained in a direction parallel to the longitudinal axis X of FIG. 3, can therefore be regular or irregular according to the pattern, or to the combination of patterns used to define its geometry, even three-dimensional.

Furthermore, each layer 12a, 12b, 12c, 12d and 12e can be produced with a pattern of deposition, and consequently a plan view conformation, different from the layer 12e, 12d, 12c, 12b and 12a that immediately follows it and/or precedes it (above or below it).

According to some embodiments, a plurality of layers 12 with a linear pattern (for example the layer 12e of FIG. 1), in which the pattern of deposition is parallel to the longitudinal axis X, could be alternated with a plurality of layers 12 with a linear pattern 12d and 12c, in which the pattern of deposition is not parallel to the longitudinal axis X and is therefore inclined, for example by 45°, with respect thereto.

According to possible embodiments, the structure 11 can comprise a layer 12e made with a pattern of deposition different from the pattern of deposition of at least another layer 12a.

The structure 11 could comprise a plurality of contiguous layers 12 made with the same pattern of deposition, for example alternating with an additional plurality of layers 12 made with a pattern of deposition different from each other.

Therefore, the plan view conformation of each of the layers 12 is variable at least as a function of the height H of the structure 11, so as to create a plurality of zones 24 and 25 that have different mechanical properties, such as the elastic modulus, density and lift, for example.

The structure 11 could comprise a plurality of the layers 12 made with a polygonal pattern, for example hexagonal, alternating with a plurality of layers 12 made with a linear pattern, parallel to each other or inclined with respect to a particular direction of deposition, alternating with an additional plurality of layers 12 that have a polygonal pattern.

According to some embodiments, the height, or thickness, of each layer 12 is comprised between 0.05 mm and 2 mm, preferably between 0.1 mm and 1 mm, even more preferably between 0.1 mm and 0.5 mm.

According to some embodiments, the structure 11 can comprise layers 12 made of different materials. For example, the first layer 12a (FIG. 6) can be made by printing a second filament 130, while the remaining layers 12 constituting the structure 11 could be made by printing a first filament 13.

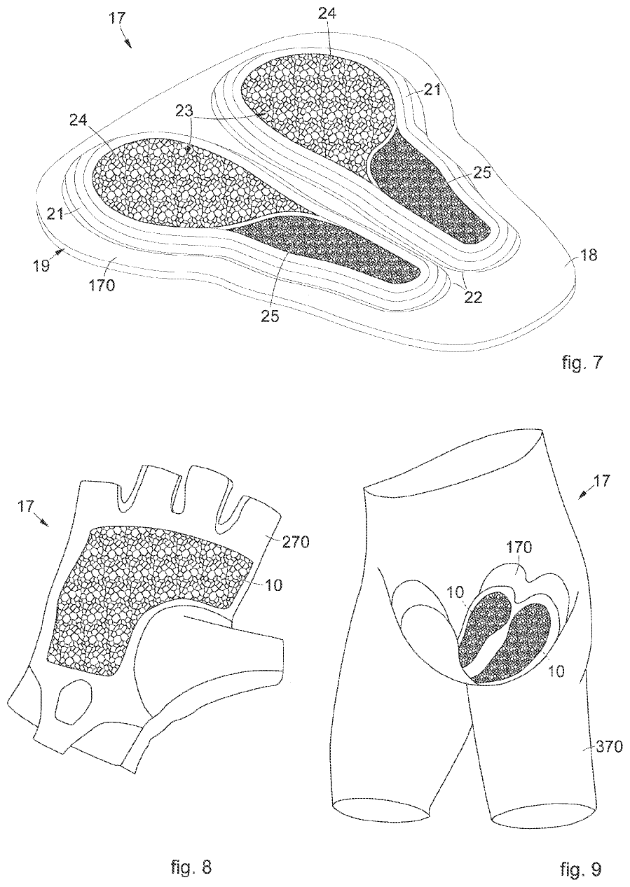

According to some embodiments, the padding 10 can be associated with a sports garment 17 (FIGS. 3, 6, 7 and 8), for example, the padding 10 could be associated with a chamois 170 (FIGS. 3, 7 and 8), with a glove 270 (FIG. 7), with a pair of shorts 370 (FIG. 8), with a helmet, with an insole but also with knee and elbow pads.

The chamois 170 (FIGS. 3 and 6) could be produced by associating a padding 10 with a portion of fabric 18 (FIGS. 3 and 4) configured to be subsequently associated with, or located in, the crotch portion of a pair of sports shorts 370 (FIG. 8).

The portion of fabric 18 (FIGS. 3 and 4) can comprise a plurality of layers 19 made of different materials which are configured to improve the comfort and breathability of the chamois 170 during its use.

For example, the portion of fabric 18 could comprise a first layer 19a made of fabric, natural or synthetic material, a second layer 19b of foam and a third layer 19c of jersey.

The layers 19 can be coupled using methods that provide to use flames or glues.

According to possible embodiments, not shown in the attached drawings, the portion of fabric 18 can be made in a single layer 19, also called “in a single body”, for example made of layered material, comprising a plurality of materials inside it, such as polyester, polyamide, or polyurethane, for example.

According to some embodiments, the portion of fabric 18 comprises polyurethane or its derivatives.

For example, the portion of fabric 18 can be made entirely of polyurethane, alternatively, at least one of the layers 19a, 19b and 19c could be made of polyurethane or its derivatives.

For example, the material used to make the first layer 12a can have a different hardness from the material used to make the remaining layers 12, this advantageously allows to improve the adhesion of the padding 10 to the portion of fabric 18.

The padding 10 can comprise an external perimeter zone 21, which has an external edge 22 the height H1 of which tends to zero, and at least one central zone 23, continuous to the external perimeter zone 21, which has a height H2 greater than the height H1 of the external edge 22.

The height H of the padding 10 increases linearly from the external perimeter zone 21 to the at least one central zone 23. In this way, the comfort and fit of the sports garment 17 are improved.

The ratio between H1 and H2 is such that the angle α, which represents the inclination of the external perimeter zone 21, is comprised between 30° and 70°, preferably between 40° and 65°, even more preferably between 45° and 60°.

The height H2 of the central zone 23 can have a value comprised, for example, between 0.2 mm and 30 mm, preferably between 4 mm and 15 mm, even more preferably between 6 mm and 12 mm.

Furthermore, the zones 24 and 25, which have different mechanical properties, such as the elastic modulus for example, can be comprised in the central zone 23.

This can be achieved by making the various layers 12 of the zones 24 and 25 with different patterns of deposition from each other, or with different filaments. For example, the zone 24 can be made by overlapping with each other a plurality of layers 12 that have a hexagonal plan view conformation and a plurality of layers 12 that have a linear plan view conformation.

In this way, the elastic modulus, the elastic response and other mechanical properties will depend on the particular structure 11 made by overlapping the different layers 12 with each other, and on the material with which the filaments 13, 130 are made.

The zone 24 could be made by overlapping with each other a plurality of layers 12 that have a plan view conformation with rings, a plurality of layers 12 that have a plan view conformation with hexagons and a plurality of layers 12 that have a linear plan view conformation.

The zone 24 could be made with a thermoplastic material different from that used to make the zone 25, for example, the two materials could have a different hardness.

In this way, the structure 11 of the zone 24 will be different from that of the zone 25, and these can be designed to better resist stresses.

For example, the chamois 170 could comprise a zone 24 that is stiffer and more compact than the zone 25, its shape could be configured to adapt to the ischial-perineal zone of the user and dampen the stresses on this particular part of the body more.

Furthermore, the padding 10 could comprise portions, or zones, made with a number of layers 12 different from each other. For example, the zone 24 could be made with a number of layers different from the number of layers 12 with which the zone 25 is made.

In this way, as well as modifying the plan view conformation of each layer 12, the filament 13 creates a structure 11 in which the cross section conformation (FIG. 4), obtained in a direction perpendicular to the longitudinal axis X of FIG. 3 and therefore in a direction perpendicular to the plan view conformation, also has a plurality of solids and voids disposed in an irregular manner.

The amount of material, due to the deposition of the filament 13, and the particular disposition of the voids, will characterize the final shape of the padding 10, its structure 11 and its mechanical properties.

In addition, the presence of numerous voids will facilitate the passage of air during use, improving comfort and breathability, allowing for a better thermal flow and decreasing the proliferation of bacteria.

Hereafter in the description, the term filling will indicate the percentage of solids with respect to that of voids, with respect to the total surface of each layer 12.

For example, a layer 12 with a filling of 70% indicates a layer in which the surface of the solids, that is, of the filaments 13, 130 covers 70% of the total surface of the layer 12.

The conformation of the structure 11 allows for a better compressive strength, decreasing the possibility of yields occurring caused by the peak load, also known as the “buckling effect”, in the padding 10.

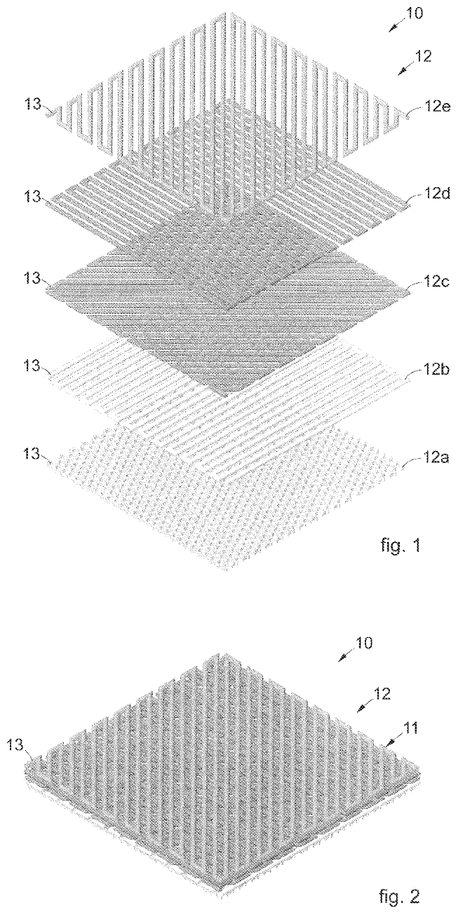

The padding 10 can be made in a single body (FIGS. 2, 3 and 7), moreover, according to some embodiments, it can be made in several portions associated with each other (FIG. 6), for example to allow a better adaptation to the shapes of the user's body.

According to some embodiments, a method for producing a padding 10 provides to deposit, by means of 3D printing, one or more filaments 13, 130 at a speed comprised between 400 mm/min and 4200 mm/min, preferably between 450 mm/min and 3000 mm/min, even more preferably between 500 mm/min and 1800 mm/min.

In this way, the adhesion between the padding 10 and the portion of fabric 18 is advantageously improved.

According to some embodiments, it can also be provided to deposit the filament/s 13, 130 with different speeds as a function of the different zones of the padding. In particular, a first deposition speed used to make an external edge 22 of the padding 10 and/or a peripheral portion thereof can be lower than a second deposition speed used to fill a central zone 23 delimited by the external edge 22 and/or by the peripheral portion.

According to some embodiments, the second deposition speed can be comprised between 1.2 and 6 times the first deposition speed, preferably between 1.5 and 3 times.

For example, in correspondence with the edge, the deposition speed can be comprised between 400 and 1000 mm/min, preferably between 450 and 800 mm/min, even more preferably between 500 and mm/min and 700 mm/min, while in correspondence with the central zone it can be comprised between 1000 and 4,200 mm/min, preferably between 1,200 and 3,000 mm/min, even more preferably between 1,200 and 1,800 mm/min.

According to some embodiments, the method provides that the 3D printing occurs at a printing temperature TS comprised between 170° C. and 260° C., preferably between 200° C. and 250° C., even more preferably between 220° C. and 240° C.

During printing, the filament 13, 130 therefore reaches a temperature that allows it to adhere to the portion of fabric 18 and guarantees its resistance and durability over time.

According to one possible embodiment, shown in FIG. 7, the padding 10, for example made in a single body, can be associated with a glove 270, disposed on the portion of the palm of the hand.

Furthermore, the padding 10 can be associated with a pair of shorts 370 (FIG. 8), for example cycling shorts, in the crotch portion.

The padding 10 could be directly associated with the pair of shorts 370 or, alternatively, it could be associated with the portion of fabric 18 and subsequently associated with the pair of shorts 370.

Advantageously, the padding 10 and the method described to obtain it described in the present invention, allow to obtain a structure 11 which, in association with the materials chosen to produce it, allows to eliminate the constant load yielding zone typical of known paddings. This greatly improves the comfort of the padding 10 and increases the sense of softness perceived by the user during its use.

It is clear that modifications and/or additions of parts may be made to the padding 10 and to the method as described heretofore, without departing from the field and scope of the present invention, as defined by the claims.

It is also clear that, although the present invention has been described with reference to some specific examples, a person of skill in the art shall certainly be able to achieve many other equivalent forms of paddings and methods or producing such paddings, having the characteristics as set forth in the claims and hence all coming within the field of protection defined thereby.

In the following claims, the sole purpose of the references in brackets is to facilitate the reading of the claims and they must not be considered as restrictive factors with regard to the field of protection defined thereby.

1. Method for producing a padding (10) by means of 3D printing by deposition of at least one first filament (13), characterized in that said at least one first filament (13) is deposited directly onto a portion of fabric (18) to make at least the first layer (12a) of a plurality of layers (12) that define a multi-plane structure (11).

2. Method as in claim 1, characterized in that said at least one first filament (13) is made of thermoplastic elastomer material (TPE).

3. Method as in claim 1, characterized in that said at least one first filament (13) has a hardness comprised between 40 Shore A and 95 Shore A, preferably comprised between 50 Shore A and 90 Shore A, even more preferably comprised between 50 Shore A and 80 Shore A.

4. Method as in claim 1, characterized in that said portion of fabric (18) comprises polyurethane or its derivatives.

5. Method as in claim 1, characterized in that at least one portion of said structure (11) is made by depositing at least one second filament (130) having a different hardness from said hardness of said first filament (13).

6. Method as in claim 5, characterized in that said first and/or second filaments (13, 130) are deposited at a speed comprised between 400 mm/min and 4200 mm/min, preferably between 450 mm/min and 3000 mm/min, even more preferably between 500 mm/min and 1800 mm/min.

7. Method as in claim 1, characterized in that said at least one first filament (13) is deposited with differentiated speed as a function of the different zones of said padding (10), wherein a first deposition speed used to make an external edge (22) of said padding (10) and/or a peripheral portion thereof is lower than a second deposition speed used to fill a central zone (23) delimited by said edge and/or said peripheral portion.

8. Method as in claim 7, characterized in that said second deposition speed is comprised between 1.2 and 6 times said first deposition speed, preferably between 1.5 and 3 times.

9. Method as in claim 1, characterized in that the printing temperature TS is comprised between 170° C. and 260° C., preferably between 200° C. and 250° C., even more preferably between 220° C. and 240° C.

10. Method as in claim 1, characterized in that said portion of fabric (18) is comprised in, or associated with, a sports garment (17).

11. Method as in claim 1, characterized in that said structure (11) comprises at least one layer (12b, 12c, 12d, 12e) made with a pattern of deposition that is different from the pattern of deposition of said first layer (12a).

12. Method as in claim 1, characterized in that each layer (12a, 12b, 12c, 12d, 12e) of said plurality of layers (12) is made with a pattern of deposition, and consequently a plan view conformation, that is different from the layer (12e, 12d, 12c, 12b and 12a) that immediately follows and/or precedes it.

13. Method as in claim 1, characterized in that it provides to create a plurality of zones (24 and 25) that have different mechanical properties from each other, such as elastic modulus, density and lift, by varying the plan view conformation of each of said plurality of layers (12) at least as a function of the height (H) of said structure (11).

14. Padding (10) produced by means of a method as in claim 1.

15. Padding (10) as in claim 14, comprising an external edge (22) and at least one central zone (23), characterized in that said height (H) increases linearly from said external edge (22) to said at least one central zone (23).

16. Sports garment (17) characterized in that it comprises at least one padding (10) made by means of a method as in claim 1 and/or a padding (10).

17. Sports garment (17) as in claim 16, characterized in that said sports garment (17) is a chamois (170) or a glove (270).

18. Sports garment (17) as in claim 16, characterized in that said sports garment (17) is a pair of shorts (370) comprising, in correspondence with the crotch portion, an external surface suitable to be positioned, during use, in contact with a bicycle saddle, and an opposite internal surface which, during use, is at least partly in contact with the skin of a user, wherein said padding (10) is associated with said internal surface.
